(19) United States
(12) Patent Application Publication
(10) Pub. No.: US 2008/0223981 A1
(43) Pub. Date: Sep. 18, 2008

(54) GROUND EFFECT GLIDER

(75) Inventors: Gerald M. Angle, Morgantown, WV (US); James E. Smith, Bruceton Mills, WV (US)

Correspondence Address: THOMPSON HINE L.L.P.;Intellectual Property Group, P.O. BOX 8801, DAYTON, OH, 45401-8801, US

(73) Assignee: ADVANCED TECHNOLOGY APPLICATIONS, Morgantown, WV (US)

(21) Appl. No.: 12/049,823

(22) Filed: Mar. 17, 2008

Related U.S. Application Data
(60) Provisional application No. 60/918,396, filed on Mar. 16, 2007.

(51) Int. Cl. B64C 31/02

(52) U.S. Cl. 244/16; 244/35 R

(57) ABSTRACT

A glider including a center section configured to receive and support an operator thereon, and a pair of air-foil shaped wings extending generally outwardly from the center section. The glider is configured such that when the glider supports the operator thereon the glider is glidable down an incline in the ground effect zone of the incline, and is configured such that the glider cannot sustainably glide above the ground effect zone.

This application claims priority to U.S. Provisional Application Ser. No. 60/918,396, filed on Mar. 16, 2007, the entire contents of which are hereby incorporated by reference.

The present invention is directed to a glider, and more particularly, to a glider which utilizes ground effect for low-altitude gliding.

### BACKGROUND

Most existing aircraft (including powered and unpowered aircraft, such as gliders) are designed to achieve and maintain a desired altitude. These aircraft are thus designed for open-air flight, and typically avoid close proximity to the ground until it is time to land, or have some other reason to make a ground approach. When flying close to the ground, aircraft experience ground effect, which alters the aerodynamic characteristics of the aircraft and results in a “cushioning” effect. However, since the majority of flight is in higher atmospheric regimes, most existing aircraft are not designed for flight in ground effect.

Flying in ground effect presents instabilities due to fluctuations in the terrain, wind, and boundary layer conditions, all of which affect the location of the center-of-pressure and therefore the pitch stability of the aircraft. However, ground effect provides an increase in lift due to the reduction of wingtip vortices and drag, and an increase in the pressure between the wind and the ground. Accordingly, the potential exists to exploit the ground effect for favorable flight conditions.

### SUMMARY

In one embodiment, the invention is a ground effect glider which exploits the ground effect for favorable flight. More particularly, the glider may be designed for downhill gliding in which the glider follows the contour of an incline which generally corresponds to the glide slope of the aircraft. The aircraft may utilize an airfoil that provides passive control of the center-of-pressure location, and in turn the pitch of the aircraft, by limiting travel of the center-of-pressure.

In particular, in one embodiment the invention is a glider including a center section configured to receive and support an operator thereon, and a pair of air-foil shaped wings extending generally outwardly from the center section. The glider is configured such that when the glider supports the operator thereon the glider is glidable down an incline in the ground effect zone of the incline, and is configured such that the glider cannot sustainably glide above the ground effect zone.

### BRIEF DESCRIPTION OF THE DRAWINGS

FIG. 1 illustrates various views of one embodiment of the glider of the present invention;

FIG. 2 is a front perspective view of another embodiment of the glider of the present invention;

FIG. 3 is a front perspective view of another embodiment of the glider of the present invention;

FIG. 4 is a front perspective view of another embodiment of the glider of the present invention;

FIG. 5 is a front perspective view of another embodiment of the glider of the present invention;

FIG. 6 is a front perspective view of another embodiment of the glider of the present invention;

FIG. 7 illustrates the glider of FIG. 6, folded into a compact state;

FIG. 8 is a profile of an airfoil having a flared trailing edge, compared to a baseline airfoil;

FIG. 9 is a profile of an airfoil having a slot, compared to a baseline airfoil;

FIG. 10 graphically represents the center-of-pressure locations vs. angle of attack for a variety of flared trailing edge airfoil configurations;

FIG. 11 graphically represents the total change in center-of-pressure location for the flared trailing edge airfoil configurations of FIG. 10;

FIG. 12 graphically represents variations in the lift coefficient for the flared trailing edge airfoil configurations of FIG. 10;

FIG. 13 graphically represents variation in the drag coefficient for the flared trailing edge airfoil configurations of FIG. 10;

FIG. 14 graphically represents the center-of-pressure locations vs. angle of attack for a variety of slotted airfoil configurations;

FIG. 15 graphically represents the total change in center-of-pressure location for the slotted airfoil configurations of FIG. 14;

FIG. 16 graphically represents variations in the lift coefficient for the slotted airfoil configurations of FIG. 14;

FIG. 17 graphically represents variation in the drag coefficient for the slotted airfoil configurations of FIG. 14;

FIG. 18 graphically represents variations in the lift coefficient for various airfoils;

FIG. 19 graphically represents variations in the lift coefficient for the airfoils of FIG. 18;

FIG. 20 graphically represents variations in the drag coefficient for the airfoils of FIG. 18;

FIG. 21 illustrates various braking devices;

FIG. 22 is a schematic representation of various tail configurations; and

FIG. 23 is a side schematic representation of an aircraft gliding down a ski slope.

### DETAILED DESCRIPTION

The invention may take the form of an un-powered recreational craft, vehicle or aircraft 10, such as a glider or sailplane. The aircraft 10 may be configured to spend a predominant amount of its flight time in close proximity to the ground (i.e., in one case, within about 25-50% of the chord length of the aircraft 10). Such an aircraft 10, on level ground, would have a short flight profile. However, when operated over a gradual declined slope (such as a ski slope 15, shown in FIG. 23), where the average angle of slope is similar or matched to the glide slope of the aircraft 10 (i.e. within about 10%, or within about 30% of each other), the aircraft 10 can maintain longer flight duration.

As will be described in greater detail below, the aircraft 10 may be designed to utilize the ground effect to maximize lift of the aircraft 10. Moreover, should the aircraft 10 rise out of the ground effect, the aircraft 10 would experience a loss of lift such that the aircraft 10 is gently guided back into the ground effect zone. The aircraft 10 may have a relatively high drag such that gliding speeds are relatively low. Finally, the aircraft 10 may utilize an airfoil which provides pitch stability to provide a stable, easy-to-control aircraft.

Due to its high drag (and low speed), natural inclination to remain in the ground effect regime, and pitch stability, the aircraft 10 may be easy and safe to operate. Thus a pilot/operator with minimal training may be able to operate the aircraft 10. In addition, due to the small size and low altitude of the aircraft 10, the pilot/operator may not be required to have any sort of license to operate the aircraft 10. The aircraft 10 may lack any sort of an engine, propeller, or other thrust-generating device, instead relying solely on gravity to glide downhill as a recreational downhill glider.

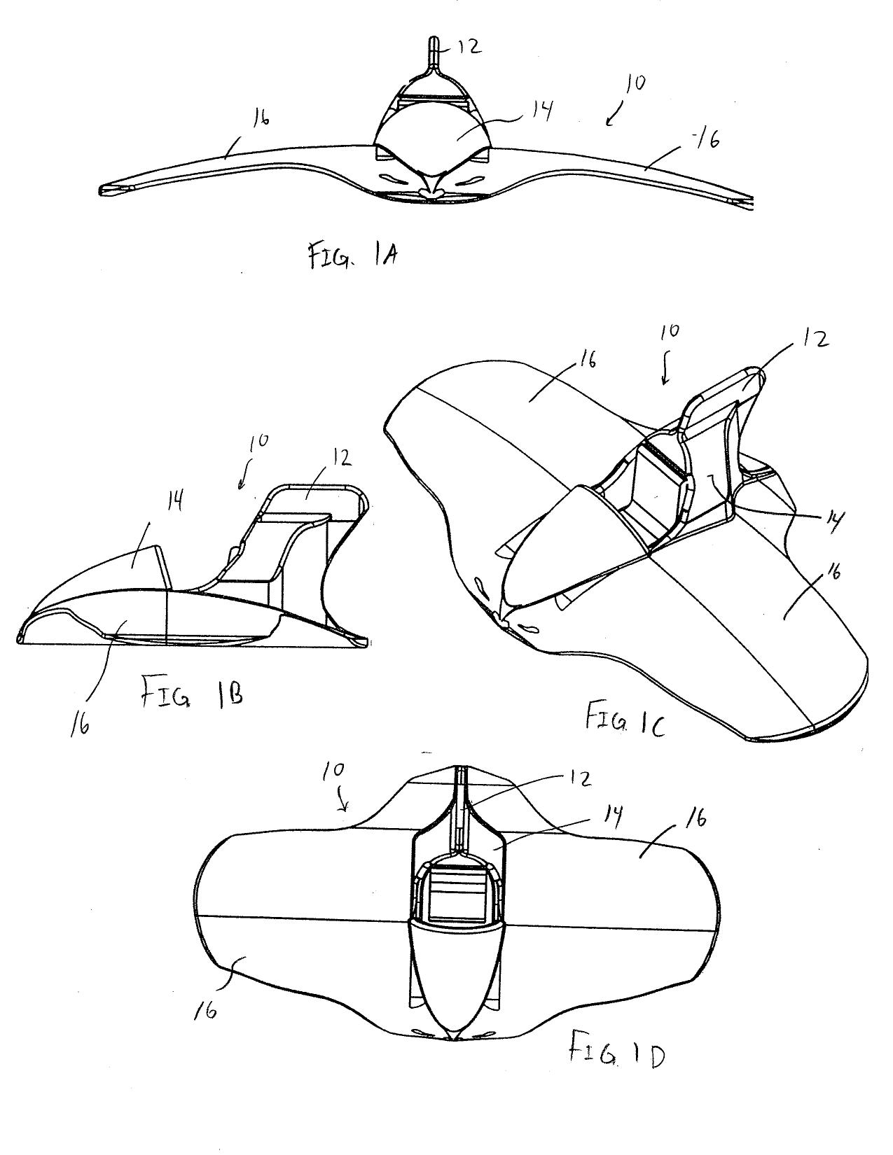

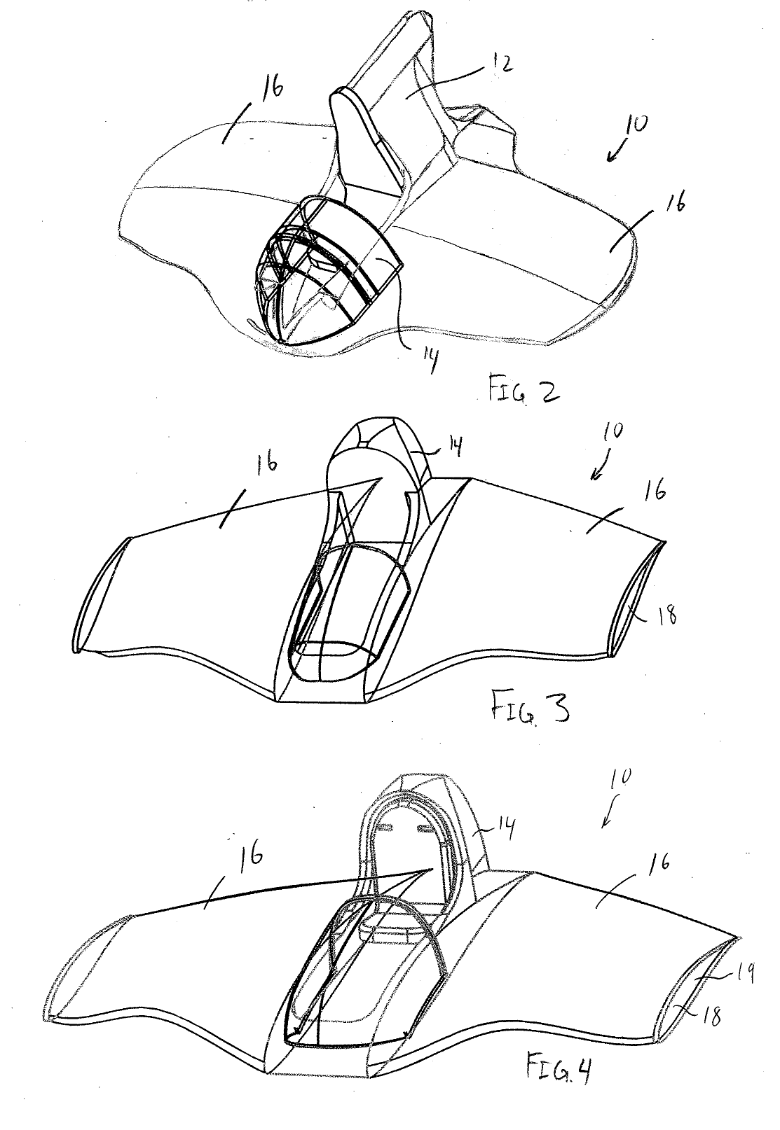

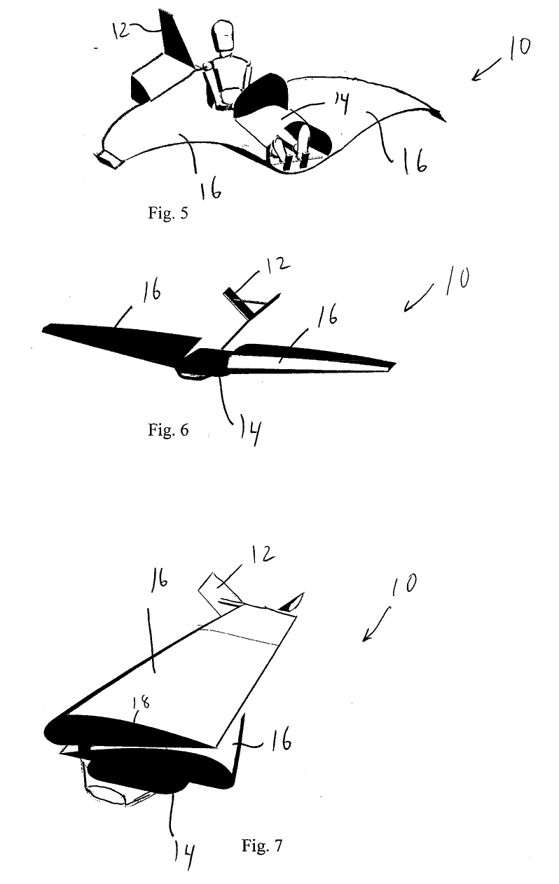

The basic configuration of the aircraft 10 can take any of a wide variety of shapes for known gliders and/or sailplanes. For example, FIGS. 1-6 illustrate various differing configurations of the aircraft. In the embodiments of FIGS. 1-5, aircraft 10 has a shape similar to a flying wing with a vertical tail 12. A fuselage, center section, or cockpit 14, is provided between the wings 16 which extend outwardly therefrom. The fuselage 14 provides a seat to support an upright pilot/operator. The seat may be slightly inclined when the aircraft 10 rests on level ground, such that in flight the pilot/operator is in an upright position. A face shield/windshield/wind screen (not shown) may be mounted to the fuselage 14 to protect the pilot/operator from wind, air borne particles or ground based objects. Mirrors may be mounted to the aircraft 10 to improve the pilot/operator's visualization, providing nearly 360 degree visibility.

The aircraft 10 may have a seatbelt, four- or five-point harness, or the like to secure the pilot/operator to the fuselage 14. The harness may be adjustable along the length of the aircraft 10 to ensure that the pilot/operator is positioned at the optimal forward/aft position on the fuselage 14, which can vary depending upon the pilot/operator's weight and weight distribution. The fuselage 14 may be configured to cover and protect the legs and torso of the pilot/operator and may be reinforced, such as by an embedded roll cage, to protect the pilot/operator. The pilot/operator may wear a helmet and other safety equipment as desired, and the aircraft 10 may have a roll bar to protect the pilot/operator in the occurrence of a roll-over. Moreover, rather than assuming a seating position, the aircraft 10 may be configured such that the pilot/operator lies on the aircraft 10 in a prone position. Moreover, although the embodiments described herein are configured to carry only a single pilot/operator, if desired the aircraft 10 may be configured to carry two or more riders.

The cross-sectional shape of each wing 16, or the airfoil 18 of the aircraft 10, can be any basic shape that provides the appropriate aerodynamic characteristics, although particularly useful airfoil shapes 18 are described in greater detail below. Each wing 16 may be arched, deflected or drooped at the wingtips in front view, as shown in FIG. 1A. This arched shape is similar to the wing configuration used by birds, particularly pelicans, when flying in ground effect, which helps maintain pressure under the wing. Each wing 16/airfoil 18 may be a generally rigid, fixed-wing design.

The aircraft 10 could also take the shape of a more conventional aircraft, as shown in FIG. 6. The aircraft 10 may be able to be converted/collapsed into a more compact/transportable configuration. For example, FIG. 7 illustrates one manner in which the aircraft 10 of FIG. 6 can be converted into a more compact position. In this case both wings 16 may be foldable over the fuselage 14/center axis of the aircraft, which can aid in transportation and storage of the aircraft 10. In addition, the tail 12 may be collapsible, and if desired the wings 16 and/or tail 12 may be removable, or other manipulations may be enabled, to allow the aircraft 10 to assume a compact position.

The size of the aircraft 10 can vary as desired, but in one embodiment the aircraft 10 has a wingspan of between about 6 feet and about 12 feet, a chord length of between about 2 feet and about 6 feet, and an overall length of between about 5 feet and about 10 feet. The wing plan form (the wing shape in a top view) will be determined based upon the stability criteria of the aircraft 10, but may be generally elliptical, or a geometric representation thereof. The aircraft 10 can have any of variety of weights, but in one embodiment is between about 30 lbs and about 60 lbs, or less than about 80 lbs, or less than about 150 lbs to provide the desired aerodynamic qualities, and ease of carrying/transportation. The aircraft 10 can be made of lightweight materials, such as composites, foam-filled plastic composites, or the like, to minimize its overall weight. The area of the lifting surfaces may be at least about 50 square feet, which may support 230 lbs (which could include the aircraft 10 and the pilot/operator), although total weight of the aircraft and pilot/operator may be 300 lbs. or more.

The aircraft 10 may be designed to accommodate a pilot/operator having a weight of up to about 200 or about 250 lbs, or between about 80 lbs and about 250 lbs., although various different models of the aircraft 10 can be designed for differing weights by altering the length and/or chord of the wings 16. Alternately, the aircraft 10 may have replaceable wings 16 such that the desired length/chord of wings can be utilized to customize the aircraft 10 to the weight of the particular pilot/operator (i.e. total wing area is reduced for lighter operators, and increased for heavier operators). Alternately, the aircraft 10 may have adjustable surfaces, similar to trim tabs of conventional aircraft, to adjust the aircraft's aerodynamic properties to the particular weight of the pilot/operator.

The aircraft 10 may have standard control surfaces, such as ailerons, rudders, elevators, etc. to control the roll, pitch and yaw of the aircraft 10, and may also include controls to manipulate and control such control surfaces. However, if desired, these controls may be limited and simplified as compared to those for a standard glider, since lesser control may be required due to limited speeds and simpler control due to ground effect operation.

As noted above, ground effect helps to reduce drag, thereby effectively increasing lift. However, flying in the ground effect zone can also present instabilities due to fluctuations in terrain, wind and boundary layer conditions which may cause the aircraft 10 to suddenly change its pitch. The instabilities of ground effect flight can be of particular concern in an unpowered aircraft due to the close proximity of the ground and the inability to reliably climb out of an undesirable situation.

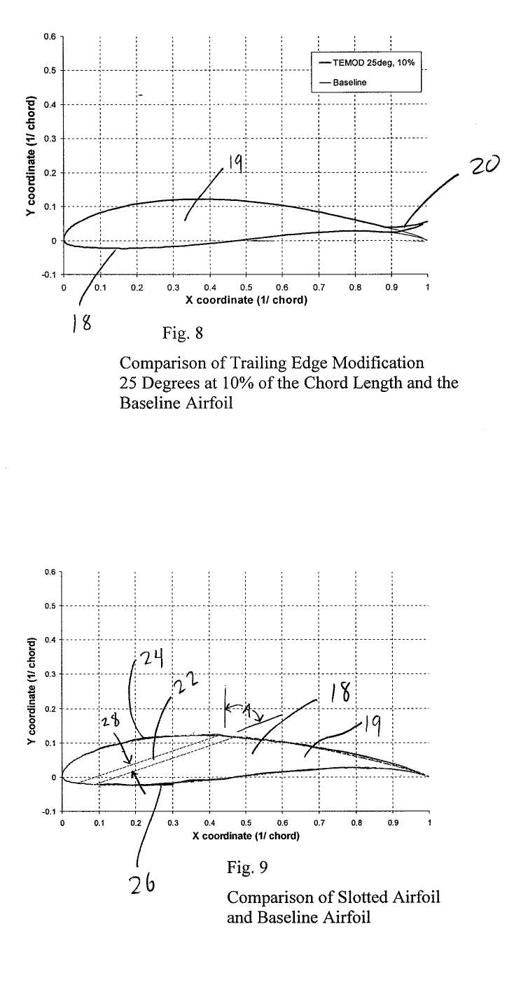

Accordingly, the wings 16/airfoil 18 of the aircraft 10 may have features that are particularly suited for use in ground effect gliding. A first of these modifications/features could be to provide an airfoil 18 having an airfoil body 19 with a trailing edge portion 20 that flairs either upwardly or downwardly, thereby changing the pressure profile with respect to an airfoil that lacks a flared trailing edge. FIG. 8 illustrates a trailing edge portion 20 that is flared upwardly, although the trailing edge portion 20 may instead be flared downwardly. Alternately, or in addition, the airfoil may have a slot 22 extending from the upper (lower pressure) surface 24 to the lower (higher pressure) surface 26, as illustrated in FIG. 9. As will be described in greater detail below, these modifications can be used either independently or simultaneously.

In the “flared trailing edge” embodiment of FIG. 9, the flaring of the trailing edge portion 20 can take any of a variety of forms. For example, the trailing edge portion 20 may define any of a variety of angles (wherein the angle is defined as the angle formed between a line through the center of the flared trailing edge portion 20 and the chord line 18 of the unmodified airfoil). In particular, in one embodiment the angle of the trailing edge portion 20 is between about 30 degrees and about −30 degrees, where a positive number represents an upward deflection, and a negative number represents a downward deflection. Although the parameters will depend upon the particular airfoil design and the desired performance, an angle of deflection between about 20 degrees and about −20 degrees for the trailing edge portion 20 may be most effective to increase the overall drag of the craft as a speed limiter.

The length of the flared trailing edge portion 20 (i.e. the generally left-to-right dimension in FIG. 8) can be varied as desired. In one embodiment, the flared trailing edge portion 20 constitutes between about 5% and about 30% of the chord length of the associated airfoil 18. Although the parameters depend upon the particular airfoil design and the desired parameter, having a flared trailing edge portion 20 that constitutes between about 5% and about 15% of the chord length of the associated airfoil may be most effective. The flared trailing edge portion 20 may extend along the entire span of each wing 16, or only part thereof (such as a majority of the span), as desired. It is also possible that the trailing edge can be flared in both directions simultaneously.

As noted above, when flying in ground effect, changing terrain and wind conditions may render the aircraft 10 particularly prone to sudden shifts in pitch due to a sudden change in the center-of-pressure. However, the flared edge portion 20 of the airfoil 18 can help to reduce travel of the center-of-pressure with respect to a change in angle of attack. In addition, the flared edge airfoil can help to increase drag, thereby slowing the aircraft 10 as desired.

A study of the effect of the flared edge upon a basic airfoil (a Wortmann FX 63-137 airfoil) was conducted using computational fluid dynamic calculations. Table 1 sets forth the parameters of the variants of the airfoils that were studied. The studied trailing edge embodiments incorporated a deflection of the trailing edge (either up or down) at a given angle, for a specified amount of the chord length. A zero degree angle of attack was defined as the condition in which the leading edge and the trailing edge of the baseline airfoil were positioned along the same horizontal line.

TABLE 1
Investigated Trailing Edge Modifications

| | Deflection | Percent Chord |
|---|---|---|
| Variation Descriptor | Angle (deg) | Effected |
| TEMOD−20deg10per | −20 | 10 |
| TEMOD−10deg10per | −10 | 10 |
| TEMOD20deg10per | 20 | 10 |
| TEMOD25deg10per | 25 | 10 |
| TEMOD30deg10per | 30 | 10 |
| TEMOD20deg5per | 20 | 5 |
| TEMOD20deg20per | 20 | 20 |

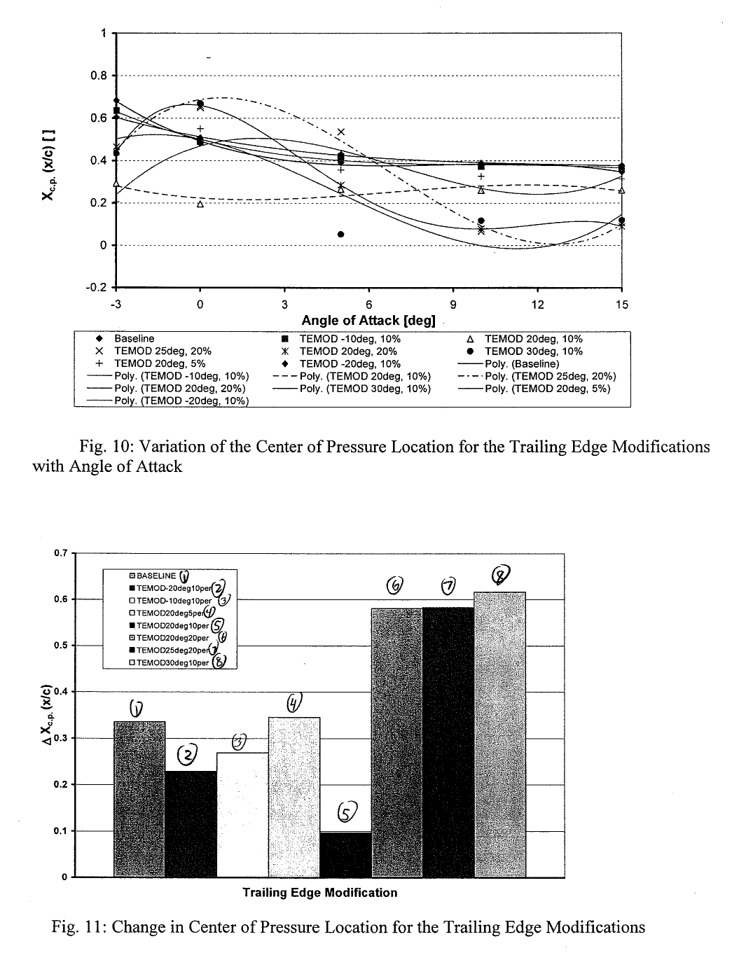

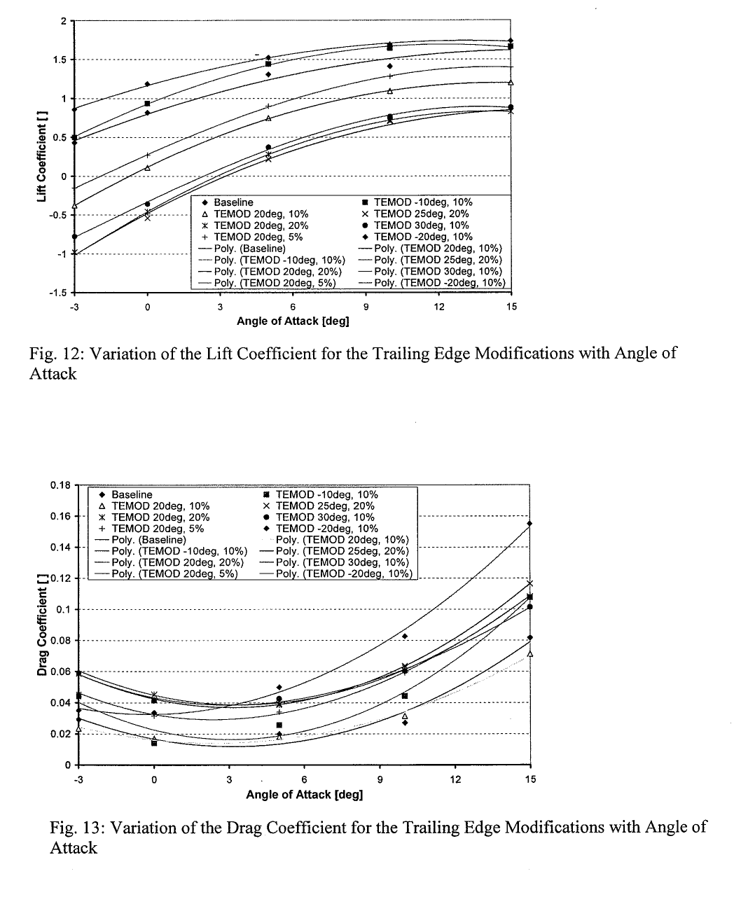

FIG. 10 illustrates the center-of-pressure locations vs. angle of attack for the configurations of Table 1. The change in center-of-pressure location with angle of attack is a key predictor of the pitch stability of the airfoil. FIG. 11 illustrates the maximum change in center-of-pressure locations for the various embodiments. From FIG. 11 it can be seen that of the seven studied trailing edge embodiments, three embodiments (the −20 degrees, 10 percent embodiment; the −10 degrees, 10 percent embodiment; and the 20 degrees, 10 percent embodiment) decreased the travel of the center-of-pressure as compared to the baseline design. Of these three, the embodiment in which the flared portion is rotated up 20 degrees, and extends along 10 percent of the chord length, provided the least fluctuation of the center-of-pressure.

The lift and drag performance of the various embodiments of Table 1 was also studied. As shown in FIG. 12, both embodiments of Table 1 wherein trailing edge is flared downwardly provide a slight increase in the lift coefficient as compared to the baseline. In contrast, in all embodiments wherein the trailed edge is flared upwardly, the lift coefficient is decreased compared to the baseline. As shown in FIG. 13, the airfoil with a 20 degree upward flare extending along 10 percent of the chord length had minimal influence on the drag characteristics of the airfoil. The other embodiments increased the drag, which, as noted above, could be desired in certain cases to help control speed or aid in turning of the aircraft 10.

As described above, another airfoil design, which includes a slot 22 formed therethrough (FIG. 9) may be utilized. The position and shape of the slot 22 can vary as desired. For example, the slot 22 can be formed at any of a variety of angles A (wherein the angle of the slot 22 is defined the angle formed between the slot 22 and a line normal to the chord line). In particular, in one embodiment the slot 22 has an angle of between about 20 degrees and about 70 degrees. Although the parameters will depend upon the particular airfoil design and the desired performance, a slot angle of less than about 40 degrees, or more particularly, between about 20 degrees and about 40 degrees, may be most effective. The slot 22 may be generally parallel to the longitudinal axis of the aircraft 10. The lower end of the slot 22 may be positioned closer to the leading edge of the airfoil 18, or closer to the nose of the aircraft 10, than the upper end of the slot 22.

The length of the gap 28 defined by slot 22 (i.e. the shortest dimension between the parallel angled lines of the slot 22 in FIG. 9) can be varied as desired. In one embodiment, the slot 22 constitutes between about 0.5% and about 6% of the chord length, and more particularly about 2% in one embodiment. The slot 22 can also be located at various positions along the length of the chord. In one embodiment, the slot 22 is positioned in the leading edge half of the chord of the airfoil 18, such as between about 15% and about 25% of leading edge of the chord (where the “position” of the slot 22 is defined by the distance between the leading edge of the airfoil 18 and the midpoint of the slot 22). Although the parameters depend upon the particular airfoil design and the desired performance, positioning the slot 22 such that the slot 22 is portioned in the leading 25% of the chord may be most effective.

If desired, the slot 22 may extend along generally the entire span of each wing 16, or at least about 90% of the span, or the majority of the span. Each slot 22 may also include various angled segments, be curved, have a converging shape, a diverting shape, etc. as desired. Flaps or louvers, which can be controlled to cover one or both ends of the slots 22, may be utilized such that the slots 22 can be utilized only when desired. Alternately, the flaps or louvers may be configured to automatically cover or uncover the slots 22 upon the occurrence of certain threshold conditions created by flight conditions. Multiple slots 22 may be utilized in a single airfoil 18, if desired.

A CFD study of the effect of adding a slot 22 to a basic airfoil (a Wortmann FX 63-137 airfoil) was conducted. Table 2 sets forth the parameters of the variants of the airfoils that were studied.

TABLE 2
Investigated Slotted Airfoil Configurations with a Slot Width
of 2% of the Airfoil Chord Length

| | Location of | Slot Orientation |
|---|---|---|
| Variation | Center of Slot | (degrees from |
| Descriptor | (% chord) | vertical) |
| X15_W2_D20 | 15 | 20 |
| X15_W2_D30 | 15 | 30 |
| X15_W2_D40 | 15 | 40 |
| X20_W2_D20 | 20 | 20 |
| X20_W2_D30 | 20 | 30 |
| X20_W2_D40 | 20 | 40 |
| X25_W2_D20 | 25 | 20 |
| X25_W2_D30 | 25 | 30 |
| X25_W2_D40 | 25 | 40 |
| X25_W2_D70 | 25 | 70 |

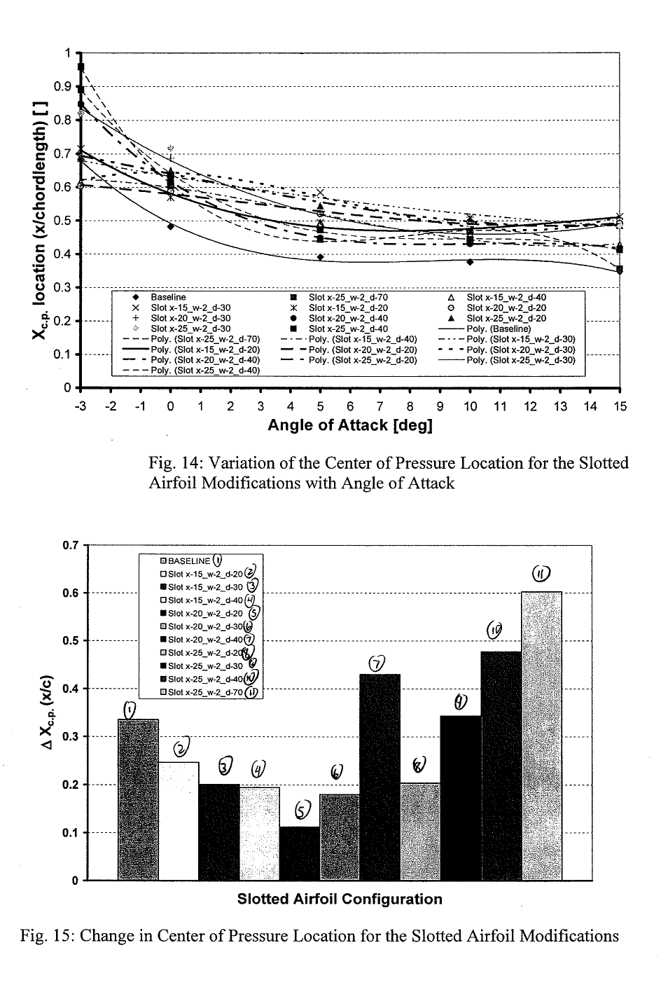

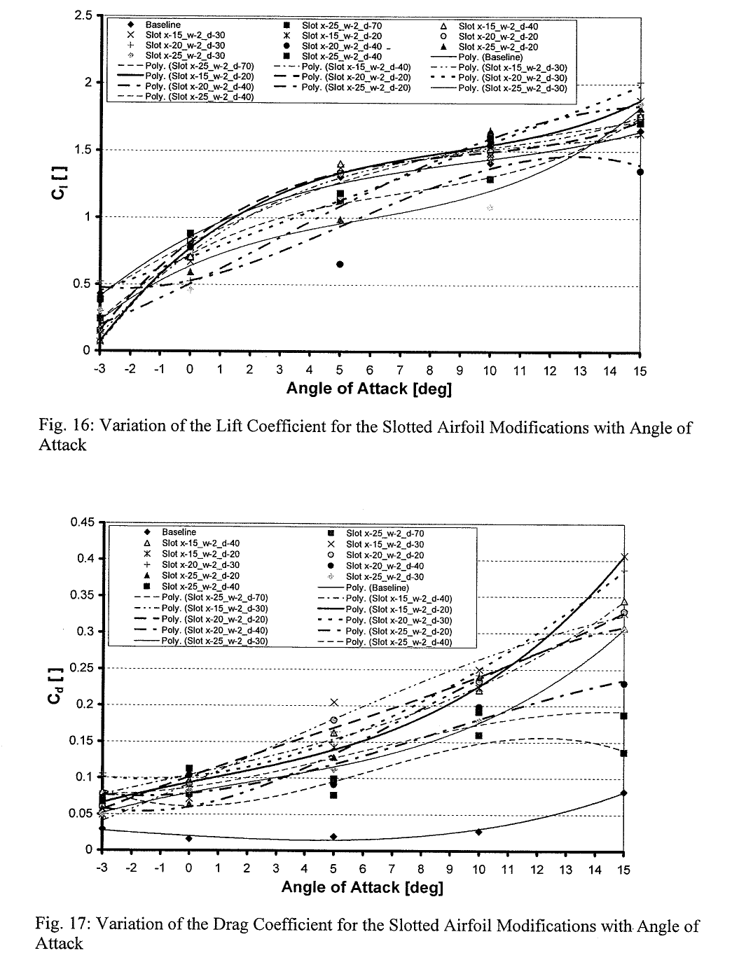

FIG. 14 illustrates the resultant data showing the center-of-pressure locations vs. angle of attack. As can be seen in FIG. 15, a number of slotted airfoil configurations provide improved performance with respect to travel of the center-of-pressure, as compared to the baseline airfoil. From FIG. 15 it can be seen that the embodiment wherein the slot is centered at 20 percent of the chord and is tilted 20 degrees aft of vertical provides the least travel of the center-of-pressure location. As shown in FIG. 16, which shows the lift curves for the slotted airfoil embodiments, the slotted airfoil modifications have less of an impact on the lift coefficient than the trailing edge modifications. As can be seen in FIG. 17, all of the slotted airfoil cases increased the drag over the baseline case, which may be desired for this field of use.

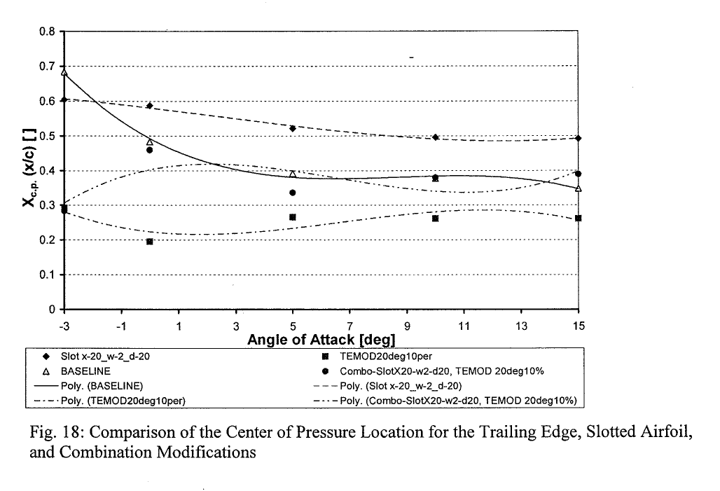

Comparing the flared trailing edge airfoil embodiment (20 degree deflection for 10% of the airfoil) and the slotted airfoil embodiment (centered at 20% of the chord and tilted 20 degrees aft of vertical) that result in the least center-of-pressure location travel provides further insight into the usefulness of these airfoils. In both cases, the travel of the center-of-pressure (travel of X_{c.p.}) is approximately 10% of the chord length. FIG. 18 compares the center-of-pressure location for the trailing edge modification and the slotted airfoil modification described above in comparison to the baseline. FIG. 18 also presents the performance of an airfoil with a combination of the features described above (i.e. a “combination” airfoil having a flared edge with a 20 degree deflection for 10% of the airfoil, and having slot centered at 20% of the chord and tilted 20 degrees aft of vertical). In this case it can be seen that the combination airfoil has slightly more variation in the center-of-pressure than each individual airfoil; although all cases have a smaller variation than the baseline airfoil.

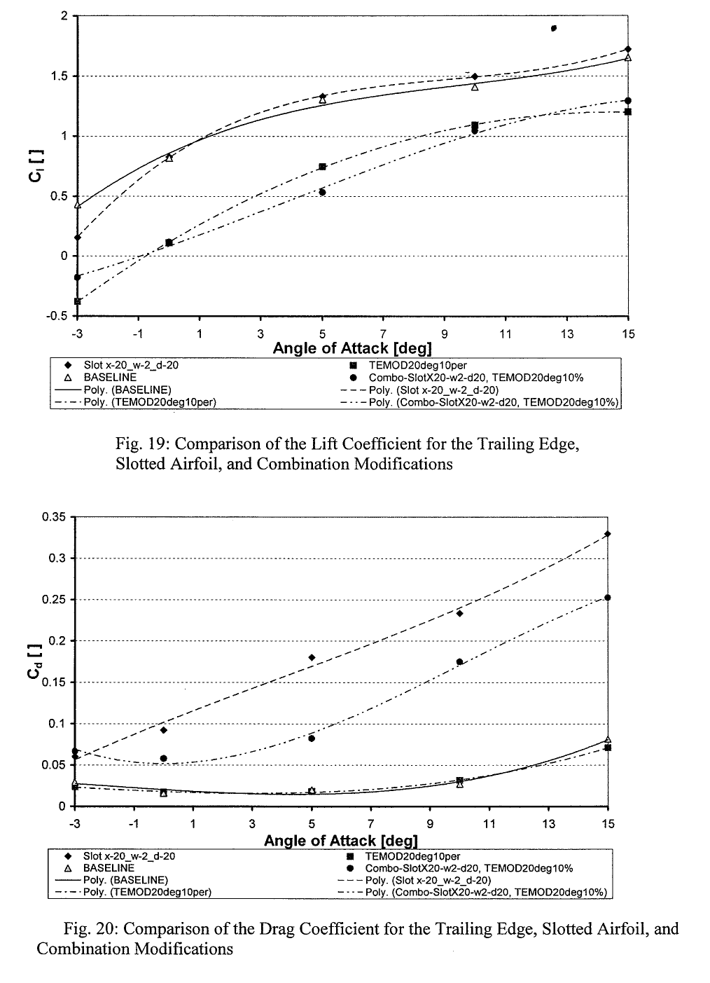

FIG. 19 compares the lift coefficient of the four airfoils considered in FIG. 18. As can be seen the combination airfoil has a larger impact on the lift coefficient. As shown in FIG. 20, the slotted airfoil embodiment has a larger impact on the drag coefficient than the trailing edge embodiment. The combination airfoil has a similar drag coefficient profile to the slotted airfoil at higher angles of attack. Accordingly, the flared trailing edge modification, the slot modification, or combinations of these modifications may be utilized to improve the desired performance of the aircraft.

Thus it can be seen that the airfoils 18 described herein help to reduce the movement of the center-of-pressure as angle of attack changes. In addition, the flared trailing edge portion 20 may be particular useful in adding drag. The slot 22 provides a mechanism to utilize the higher pressure of the wing 16 (in ground effect) to retard movement of the center-of-pressure caused by changes in the angle of the air encountered by the wing 16 (up-drafts or the air off of terrain irregularities). This, in turn, improves pitch stability. As an example, the improved pitch stability means that if the aircraft 10 flies over a mogul while in ground effect, the aircraft 10 should not significantly change its pitch, and will remain easy to control, even for a novice pilot/operator.

In addition, the arched wing shape and the flared trailing edge portion 20 help to capture and maintain the ground effect pressure under the wings 16 and also provide increased drag with velocity to act as a speed limiter. The increase in drag provided by the slots 22 could also be used to assist in the turning of the aircraft 10, provided that a manual or automatic mechanism to open and close the slots 22 is provided. The speed of the aircraft 10 may also be passively limited by increasing the coefficient of lift, which could be carried out by increasing the angle of attack, by implementing permanently deflected flaps, or by flow control. Typically, the airfoil characteristics are altered along the span of the wing 16 to increase the stability by forcing one part of the wing 16 to stall. The span-wise distribution of forces can also be utilized to reduce the amount of stress in the wing 16.

In addition, while these airfoil shapes 18 may enhance flight characteristics while in ground effect, these same attributes will inhibit the same aircraft 10 whenever the aircraft 10 rises above the ground effect threshold, which helps to maintain the desired altitude. In particular, the aircraft 10 (and in particular the wings 16) may be sized to provide adequate lift while the aircraft 10 is in ground effect. Due to the increased lift at extremely low altitudes, the aircraft 10 will have enough lift to maintain a glide slope approximately that of the inclined surface over which it is flying (it should be noted that for most aircraft the glide angle, and thus its angle of attack, is measured with respect to the horizon; however, this aircraft's angle of attach may be measured relative to the slope angle). The surface area of the lifting surfaces (i.e. wings 16) may be intentionally under-sized compared to conventional aircraft. In this case, when the altitude of the aircraft 10 is increased such that the aircraft 10 rises out of ground effect, the aircraft 10 can not sustain the altitude and the aircraft 10 glides back into ground effect.

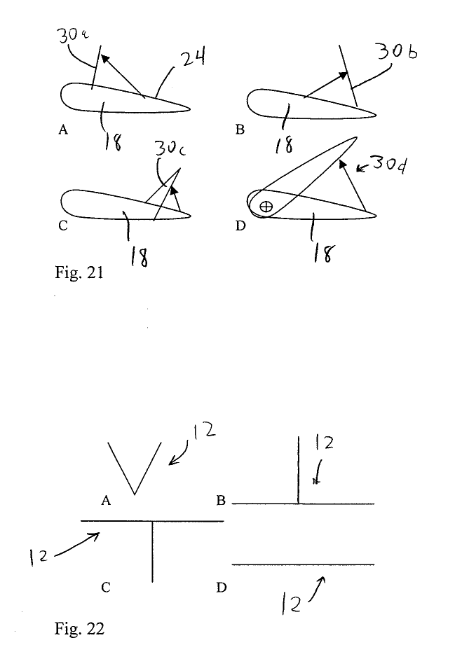

It may be desired to provide a speed limited device, which allows the operator to limit or reduce the speed of the aircraft, such as when it is desired to land/stop. Several potential embodiments of a speed limiting device 30 are illustrated in FIG. 21. For example, FIG. 21A illustrates an airfoil 18 with a forward-rotating upper member 30a in the form of a pivotable surface 30a which is pivoted upwardly/outwardly. The surface 30a may fold against or into the upper surface 24 of the airfoil 18 when the upper surface 30a is not in use (i.e. when braking is not desired). FIG. 21B illustrates an airfoil 18 with a rearward rotating upper surface 30b. FIG. 21C illustrates an airfoil with an upward rotating flap-like surface 30c. FIG. 21D illustrates rotation of the entire airfoil 18. Another embodiment would be a variation upon the configuration shown in FIG. 21C. In this variation, rather than pivoting the entire flap-like surface 30c, only the upper portion of the flap-like surface 30c is pivoted, while the lower portion remains stationary, or vice versa.

In addition, a split-flap type air-brake, in which both the upper 24 and lower 26 surfaces of the airfoil 18 are deflected, may also be used as a braking device. The split-flap type air brake may provide better control over the center-of-pressure location for the aircraft 10. These braking devices could be activated by the pilot/operator to slow the aircraft and flair the landing, although the particular air brake design will depend upon the desired pitching moment characteristics.

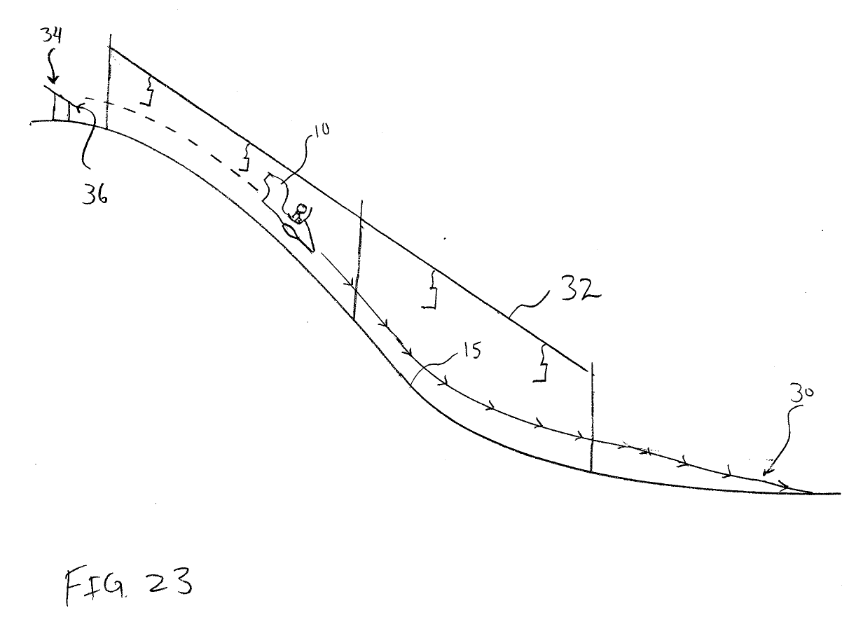

The aircraft 10 may not require a full tail; however, depending on the stability of the aircraft 10 a tail 12 could be utilized to provide additional control and pitch stability. The tail 12 could have any of a variety of configurations, such as a “V”-shaped tail (FIG. 22A), a traditional tail (FIG. 22B), a “T”-shaped tail (FIG. 22C), or a simple horizontal stabilizer (FIG. 22D). The shape of the tail 12 will depend upon the pitch control requirements of the entire aircraft based on the desired flight requirements.

Various techniques and mechanisms may be utilized in order to turn the aircraft 10. In one embodiment, the pilot/operator may simply shift his or her center-of-gravity. Alternately, an air brake mechanism, such as the air brake mechanisms shown in FIG. 21, may be utilized on one or both wings 16 to cause the aircraft 10 to turn as desired. Further alternately, all or part of the wings 16 may be twisted in opposite directions to create a turning moment, or control surfaces that induce a yaw turn may be employed. Hand and/or foot controls may be utilized to control turning, braking, etc.

The low altitude of flight also helps to limit significant rolling of the aircraft 10. In particular, the wingtips may be designed with sufficient strength such that in the case of significant rolling, the wingtips contact the ground and provide a correcting force. A split control surface could also be applied to the rudder of the aircraft 10. The split rudder may serve the primary function of speed control, but could also be used to provide yaw control. In addition, split flaperons may be provided, which provide yaw control, as well as speed control. Trim tabs on the tips and trailing edge may be implemented to increase stability.

In order to launch the aircraft 10, a platform 34 or the like (FIG. 23) may be provided at the top of the slope 15. The platform 34 may have embedded wheels, a low friction coating, or the like along its top surface for the aircraft 10 to slide along during launch. Alternately, the aircraft 10 may have wheels, skids, low friction coating, etc., that can be utilized to aid in launching. If desired, a stop or barrier may be positioned at the end of the platform 34 to stop the aircraft from launching prematurely. The end 36 of the launch platform 34 may be at a height (i.e. about 3 feet) such that the aircraft 10 is immediately introduced into the ground effect zone. In order to launch the following sequence may be utilized: 1) place the aircraft 10 in position; 2) harness the pilot/operator; and 3) release/push the aircraft 10 off of the platform.

The pilot/operator can stop the aircraft 10 simply by coming to rest on the ground at the bottom of a slope. In one case, the aircraft 10 is pitched slightly downwardly until the aircraft 10 skids to a stop. In addition, or alternately, the wings 16 may be provided the braking devices shown in FIG. 21 and described above which reduce lift and allow the aircraft 10 to glide to the ground similar to the landing of a traditional glider. The aircraft 10 could includes skid plates or wheels to aid in landing, which could be coupled to or embedded in the wingtips and/or fuselage 14 (such skid plates or wheels can also be helpful during take-off, or should the tip of a wing contact the ground during flight). Further alternately, upon sufficient slowing, the pilot/operator may be able to simply place his or her feet on the ground to accomplish a “standing” stop maneuver.

A run-out area 30 may be provided at the bottom of the slope 15 to accommodate landings, and if desired a capture net/safety fence may surround the run-out/landing area. In any case, a landing sequence could be implemented as follows: 1) fully deploy all speed control/limiting devices; 2) glide to the ground; and 3) apply brakes. If the run-out area is generally flat, the aircraft 10 will naturally slow and gently contact the ground since gravity is no longer providing the necessary motive force.

If used at a ski resort, the aircraft 10 can be transported to the top of a slope 15 by a ski lift 32 (FIG. 23) for repeated use. For example, a hook assembly may be coupled to the aircraft 10 to aid in securing the aircraft 10 to the ski lift 32. Varying-difficulty slopes of the ski resort can be utilized by pilots/operators of differing experience. For example, the ski slopes 15 may have an average incline about 5 or 10 degrees, up to about 45 degrees or more. However, it should be understood that the aircraft 10 may be able to be used over any of a variety of surfaces (land, water, ice, sand dunes, etc.), and not just ski slopes.

Accordingly, in use the aircraft 10 may fly approximately 25-50% of the chord length off of the ground (between about 2 and about 4 feet, in one embodiment), with brief peaks of higher altitude. The airfoil design 18 described herein provides stability to the pitch of the aircraft 10, and proper sizing of the aircraft 10 and its lift surfaces restricts the flight to the ground effect regime. When the aircraft 10 rises out of the ground effect regime, less lift is generated, thereby providing a limit on the altitude of the aircraft 10. Although the speed of the aircraft 10 can vary widely, the aircraft can be configured to have a top relative speed of between about 20 and 50 feet per second, and more specifically, between about 30 and about 40 feet per second, and in any case less than about 50 feet per second. For sake of comparison, an average skier may travel about 37 feet per second down an intermediate slope. Many slopes may have a significant updraft, which can desirably reduce the effective ground speed.

Having described the invention in detail and by reference to the various embodiments, it will be apparent that modifications and variations thereof are possible without departing from the scope of the invention.

What is claimed is:

1. A glider comprising:
a center section configured to receive and support an operator thereon; and
a pair of air foil shaped wings extending generally outwardly from said center section, wherein said glider is configured such that when said glider supports said operator thereon said glider is glidable down an incline in the ground effect zone of said incline, and is configured such that said glider cannot sustainably glide above the ground effect zone.

2. The glider of claim 1 wherein said glider is configured such that when gliding down said incline in the ground effect zone said glider provides sufficient lift to generally maintain its altitude, and said glider is configured such that when said glider rises above the ground effect zone, said glider provides insufficient lift to sustainably glide above the ground effect zone.

3. The glider of claim 1 wherein said glider is configured to reach a maximum relative velocity of about 40 feet/second when gliding down said incline.

4. The glider of claim 1 wherein each wing includes at least one of a flared trailing edge portion or a slot formed therethrough, wherein said slot extends from a higher pressure surface to a lower pressure surface of the associated wing.

5. The glider of claim 4 wherein each trailing edge portion forms an angle with the chord line of the associated wing of between about 30 degrees and about −30 degrees, and constitutes between about 5% and about 30% of the chord length of the associated wing.

6. The glider of claim 4 wherein the slot form an angle with a line normal to the chord line of the associated wing of between about 20 degrees and about 70 degrees, constitutes between about 0.5% and about 4% of the chord length, and is primarily positioned in the leading edge half of the chord.

7. The glider of claim 1 wherein said operator has a weight of between about 80 lbs. and about 250 lbs.

8. The glider of claim 1 wherein said glider has a weight of less than about 80 lbs.

9. The glider of claim 1 wherein said incline is at an average angle of between about 10 degrees and about 45 degrees.

10. The glider of claim 1 wherein said glider lacks any thrust-generating device.

11. The glider of claim 1 wherein said glider includes an operator-controllable air brake which, when utilized, slows the air speed of said glider.

12. The glider of claim 1 wherein each wing includes a slot formed therethrough which extends from a higher pressure surface to a lower pressure surface of the associated wing, and wherein each wing includes a surface which selectively covers and uncovers the associated slot.

13. The glider of claim 12 wherein each surface is movable by an operator between a covered position, wherein the associated surface generally covers the associated slot, and a uncovered position, wherein the association slot generally does not cover the associated slot.

14. The glider of claim 1 wherein the air foil of each wing is shaped such that the center-of-pressure is moved less than about 30% of the chord length of the associated wing when the angle of attack varies between −3 degrees and 15 degrees.

15. A glider comprising:
a center section configured to receive and support an operator thereon; and
a pair of air-foil shaped wings extending generally outwardly from said center section, wherein said glider is configured such that when said glider supports an operator thereon having a weight between about 80 lbs and about 250 lbs said glider is glidable down an incline primarily within the ground effect zone of said incline, said incline having an average angle of between about 10 degrees and about 45 degrees, wherein said glider is configured such that when gliding down said incline in the ground effect zone with said rider thereon said glider provides sufficient lift to generally maintain its altitude, and wherein said glider is configured such that 10 when said glider rises above the ground effect zone, said glider provides insufficient lift to sustain said glider above the ground effect zone such that said glider returns to the ground effect zone, and wherein said glider lacks any thrust-generating device.

16. A glider system comprising:
an incline having an average angle of incline; and
a glider including a center section configured to receive and support an operator thereon and a pair of air-foil shaped wings extending generally outwardly from said center section, wherein said glider is configured such that the glide slope of said glider generally corresponds to the average angle of said incline such that when said glider supports an operator thereon said glider is glidable down said incline in the ground effect zone of said incline, and generally does not glide above the ground effect.

17. An airfoil for use in an glider comprising:
a airfoil-shaped body having a higher pressure surface and a lower pressure surface and configured to generate lift when moved through a fluid, wherein said body includes at least one of a flared trailing edge portion or a slot, wherein said trailing edge portion forms an angle with a chord line of the body of between about 30 degrees and about −30 degrees, and wherein said trailing edge portion constitutes between about 5% and about 30% of the chord length, and wherein said slot is formed through said body and extends from said higher pressure surface to said lower pressure surface, and wherein said slot forms an angle with a line normal to the chord line of between about 20 degrees and about 70 degrees, wherein said slot has a width of between about 0.5% and about 4% of the chord length, and is primarily positioned in the leading edge half of the chord.

18. A method for operating a glider comprising:
providing a glider positioned at the top of an incline with an operator supported thereon; and
allowing said glider to glide down said include, wherein during said gliding said glider generally remains in the ground effect zone of said incline due to the configuration of said glider.

19. The method of claim 18 wherein said glider is configured such that when gliding down said incline in the ground effect zone said glider provides sufficient lift to generally maintain its altitude, and said glider is configured such that when said glider rises above the ground effect zone, said glider provides insufficient lift to sustain said glider above the ground effect zone such that said glider returns to the ground effect zone.

20. The method of claim 18 wherein said incline has an average angle of incline, and wherein a glide slope of said glider generally corresponds to the average angle of said incline.
